(19) United States
(12) Patent Application Publication
(10) Pub. No.: US 2024/0123435 A1
(43) Pub. Date: Apr. 18, 2024

(54) Metal Removal Filtering Material and Cartridge Filter

(71) Applicant: TOYO ROSHI KAISHA, LTD., Tokyo (JP)

(72) Inventors: Toshihiro Nakanishi, Seiro-machi (JP); Chika Naruoka, Seiro-machi (JP)

(21) Appl. No.: 18/277,823

(22) PCT Filed: Dec. 14, 2021
(86) PCT No.: PCT/JP2021/046149

§ 371 Date: Aug. 18, 2023

(30) Foreign Application Priority Data
Feb. 19, 2021 (JP) 2021-024792

(51) Int. Cl. B01J 39/05; B01D 15/36; B01J 39/20; B01J 41/05; B01J 41/14; B01J 47/12

(52) U.S. Cl. CPC B01J 39/05; B01D 15/362; B01J 39/20; B01J 41/05; B01J 41/14; B01J 47/12

(57) ABSTRACT

A metal removal filtering material having a basis weight of 30 to 120 g/m² including a polyethylene porous base material and graft chains fixed to the polyethylene porous base material and having a functional group. The graft chains have a graft rate of 40 to 150%. The functional group is selected from a quaternary ammonium group, a primary, secondary, or tertiary amino group, an iminodiacetic acid group, a phosphate group, and an iminodiethanol group.

### CROSS-REFERENCE TO RELATED APPLICATIONS

This application is the United States national phase of International Application No. PCT/JP2021/046149 filed Dec. 14, 2021, and claims priority to Japanese Patent Application No. 2021-024792 filed Feb. 19, 2021, the disclosures of which are hereby incorporated by reference in their entireties.

### BACKGROUND OF THE INVENTION

### Field of the Invention

The present invention relates to a metal removal filtering material and a cartridge filter.

### Description of Related Art

Recently, due to miniaturization of a semiconductor in association with advance of a semiconductor fabrication technique, a requirement for cleanliness of a chemical solution used has been severe more and more. For example, a reduction in metal impurities of a resist, a resist-relate material, such as an anti-reflection film and a multilayer film, a polymer, a monomer, an organic solvent, and the like as raw materials of these is indispensable. Especially, since metals, such as Al, Ti, Cr, Fe, Ni, and Cu, reduce a yield of the semiconductor, removal of them from a chemical solution at a high level has been required.

Currently, to remove a metal from the chemical solution used for manufacturing the semiconductor, a filter to which a metal trapping ability is given by graft polymerization method has been mainly used. For example, in Japanese Unexamined Patent Application Publication No. 2003-251118 (Patent Literature 1), a cartridge filter constituted of a fiber material produced by introducing an ion exchange group or a chelate functional group into a polyethylene nonwoven fabric by a radiation graft polymerization method is used. Additionally, in Japanese Unexamined Patent Application Publication No. 2001-515113 (Patent Literature 2), metal impurities are removed from a photoresist solvent by a cation exchange membrane made of ultra-high molecular weight polyethylene and produced by introducing a sulfonic acid group into a film having a pore diameter of about 2 μm by graft polymerization.

### CITATION LIST

### Patent Literature

Patent Literature 1: Japanese Unexamined Patent Application Publication No. 2003-251118
Patent Literature 2: Japanese Unexamined Patent Application Publication No. 2001-515113

### SUMMARY OF THE INVENTION

### Technical Problem

However, in the configuration of Patent Literature 1, there was a problem that a base material was a nonwoven fabric, gaps between fibers were non-uniform and a contact area with liquid was small, and high metal removal performance was not able to be obtained. An increase in a basis weight of the base material to increase the contacted area decreased a flow rate per unit area, and thus achieving both of the high flow rate and the high removal performance was difficult.

In Patent Literature 2, a polyethylene film having a contact area with liquid larger than that of a nonwoven fabric is used as a base material, and high metal removal performance is achieved while a high flow rate is maintained. However, the sulfonic acid group as a strong acid cation exchange group is introduced, and this causes a problem that hydrogen ions discharged when a metal is trapped denatures an organic solvent.

A cartridge filter having high metal removal performance while maintaining a flow rate per unit area and using a filtering material that does not denature the organic solvent has not been obtained yet, and development thereof has been strongly desired.

Therefore, an object of the present invention is to provide a metal removal filtering material having high metal removal performance while maintaining a flow rate per unit area and that do not denature an organic solvent, a manufacturing method of the metal removal filtering material, and a cartridge filter.

### Solution to Problem

As a result of serious studies to achieve the above-described object, the inventors have found that, in a metal removal filtering material including a polyethylene porous film and graft chains, a graft rate of the graft chains is regulated in a predetermined range, a predetermined functional group is introduced into a side chain, and a basis weight is regulated within a predetermined range, and thus a metal removal filtering material having high metal removal performance while maintaining a flow rate per unit area and not denaturing an organic solvent is obtained.

That is, the present invention is a metal removal filtering material having a basis weight of 30 to 120 g/m² and including a polyethylene porous base material and graft chains. The graft chains are fixed to the polyethylene porous base material and have a functional group. The graft chains have a graft rate of 40 to 150%. The functional group is selected from a quaternary ammonium group, a primary, secondary, or tertiary amino group, an iminodiacetic acid group, a phosphate group, and an iminodiethanol group.

The present invention is a manufacturing method of the above-described metal removal filtering material including: a step of polymerizing a vinyl group-containing reactive monomer in a polyethylene porous base material having a basis weight of 15 to 50 g/m² and a void rate of 70% or more by radiation graft polymerization to fix graft chains having a graft rate of 40 to 150%; and a step of introducing the functional group selected from the quaternary ammonium group, the primary, secondary, or tertiary amino group, the iminodiacetic acid group, the phosphate group, and the iminodiethanol group into the graft chains.

Further, the present invention is a cartridge filter including a pleating-processed filtering material, wherein the filtering material the above-described metal removal filtering material.

### Advantageous Effects of Invention

With the present invention, the metal removal filtering material having high metal removal performance while maintaining a flow rate per unit area and not denaturing an organic solvent can be provided, the manufacturing method of the metal removal filtering material, and the cartridge filter.

### BRIEF DESCRIPTION OF THE DRAWINGS

FIG. 1 is a partial cutaway perspective view of a cartridge filter of the present invention.

### DESCRIPTION OF THE INVENTION

Hereinafter, a metal removal filtering material and a metal ion removal filter of the present invention will be described in detail.

The metal removal filtering material of the present invention contains a polyethylene porous base material to which graft chains are fixed and has a basis weight of 30 to 120 g/m². The graft chains have a graft rate of 40 to 150%, and into which a functional group selected from a quaternary ammonium group, a primary, secondary, or tertiary amino group, an iminodiacetic acid group, a phosphate group, and an iminodiethanol group is introduced.

In the present invention, the polyethylene porous base material includes a porous film and a nonwoven fabric formed of high-density polyethylene, ultra-high molecular weight polyethylene, and a mixture of high-density polyethylene and ultra-high molecular weight polyethylene. The porous material is regulated to have a basis weight of 15 to 50 g/m² and a void rate of 70% or more.

Especially, the porous film having a large specific surface area and a comparatively uniform pore diameter distribution is preferred. To enhance metal removal performance, the capacity of the functional group needs to be highly maintained. Therefore, in the present invention, the basis weight and the void rate of the polyethylene porous base material are regulated to be in predetermined ranges. The basis weight of less than 15 g/m² cannot ensure strength to bear a continuous process of a roll. On the other hand, the basis weight in excess of 50 g/m² reduces the flow rate per unit area.

Additionally, the void rate of the polyethylene porous base material of less than 70% decreases the contact area with liquid and cannot obtain high metal removal performance. A bubble point as an index representing the pore diameter and air flowability or water flowability equivalent to a flow rate of a fluid are also important as properties of the polyethylene porous base material. The bubble point is preferably in a range of 10 to 30 kPa, and water flow rate is preferably 30 mL/min-cm² or more.

The polyethylene porous film as the polyethylene porous base material, for example, can be manufactured by the following method. First, high-density polyethylene or/and ultra-high molecular weight polyethylene are uniformly mixed with a solvent using a twin-screw extruder. As the solvent, for example, decalin, paraffin, and phthalic acid ester can be used. The temperature in this respect is equal to or more than the melting point of polyethylene.

After extrusion molding is performed on the obtained mixed product with a T-die mounted on the distal end of the extruder, the product is cooled and processed in a film shape. Next, this film is immersed in a volatile organic solvent, such as methylene chloride, to extract and remove a solvent. Afterwards, the product is longitudinally and laterally extended and heat-setting is performed as necessary to obtain a polyethylene porous film having predetermined basis weight and void rate. Note that the basis weight and the void rate of the polyethylene porous film can be appropriately adjusted according to the ratio between the polyethylene and the solvent and longitudinal and lateral extension magnifications.

The metal removal filtering material of the present invention can be manufactured by polymerizing a vinyl group-containing reactive monomer in the polyethylene porous base material as described above by radiation graft polymerization, fixing graft chains with a graft rate of 40 to 150%, and then introducing a functional group selected from a quaternary ammonium group, a primary, secondary, or tertiary amino group, an iminodiacetic acid group, a phosphate group, and an iminodiethanol group into the graft chains.

The metal removal filtering material of the present invention can be manufactured by performing a batch process on a sheet-shaped polyethylene porous base material. Alternatively, the metal removal filtering material may be manufactured by performing a continuous process on a roll-shaped polyethylene porous base material.

The radiation graft polymerization is a technique that irradiates a base material made of a high-polymer material with radiation, such as electron beam and y ray, to generate radical, brings it in contact with a monomer having a vinyl group, and chemically grafts a polymer chain having an objective function on the base material starting from the radical. This allows arbitrarily controlling the number and the length of the graft chains and allows introducing the graft chains into high-polymer materials having various shapes.

In the present invention, after the polyethylene porous base material is irradiated with radiation, the product is immersed in reactive monomer liquid for reaction. Thus, the graft chains are fixed to the polyethylene porous base material to manufacture a graft base material. The reactive monomer is selectable from, for example, glycidyl methacrylate having a vinyl group, styrene, chloromethylstyrene, and acrylonitrile. However, the graft rate is regulated to be 40 to 150%. The graft rate of less than 40% fails to obtain high metal removal performance. On the other hand, when the graft rate exceeds 150%, when a pleating process is performed on the metal removal filtering material, a crack occurs in a fold line, thus failing to ensure completeness of the filter.

Note that the graft rate of the graft chains can be calculated using masses before and after the graft polymerization. That is, the graft rate is calculated by the following formula.

Graft rate (%)=100×(Mass of graft chains)/(Mass of polyethylene porous base material)=100×((Mass of graft base material)−(Mass of polyethylene porous base material))/(Mass of polyethylene porous base material) [Math. 1]

The graft rate can be controlled by a condition at graft polymerization, especially an exposure dose and a monomer concentration. For example, when the exposure dose and the monomer concentration are high, the graft rate becomes high. On the other hand, when the exposure dose and the monomer concentration are low, the graft rate lowers.

Next, the graft base material is immersed in a functional group introduction chemical solution to introduce a functional group having metal removal ability into graft side chains. The functional group introduction chemical solution is selected according to the objective functional group, such as salt containing a functional group having a metal removal function. For example, in the case of an iminodiacetic acid group, the functional group introduction chemical solution is a sodium iminodiacetate aqueous solution, in the case of a phosphate group, the functional group introduction chemical solution is a phosphoric acid aqueous solution, and in the case of an iminodiethanol group, the functional group introduction chemical solution is a diethanolamine aqueous solution. Note that the functional group introduction chemical solution in the case of the conventional sulfonic acid group is a sodium sulfite aqueous solution or the like.

Finally, as necessary, acid pickling and water cleaning are performed to obtain the metal removal filtering material of the present invention. The functional group is required not to denature the organic solvent. The functional group in the present invention is selected from a quaternary ammonium group, a primary, secondary, or tertiary amino group, an iminodiacetic acid group, a phosphate group, and an iminodiethanol group into the graft chain. Since these functional groups do not discharge hydrogen ions during trapping a metal, the organic solvent is not denatured.

Since further excellent metal removal performance is provided, an iminodiacetic acid group, a phosphate group, or an iminodiethanol group having a chelate function is preferred. Note that the chelate function refers to a function that binds to specific metal ions and forms a complex to capture metal ions.

Thus, the metal removal filtering material of the present invention including the polyethylene porous base material and the graft chains fixed to the polyethylene porous base material and having the functional group and having the basis weight of 30 to 120 g/m² is obtained. With the metal removal filtering material having the basis weight of less than 30 g/m², the amount of the functional group is small and high metal removal performance cannot be obtained. On the other hand, with the metal removal filtering material having the basis weight in excess of 120 g/m², a water flow rate becomes less than 30 mL/min-cm², and process efficiency decreases.

Note that the basis weight in the metal removal filtering material can be controlled by, for example, the graft rate. For example, when the graft rate is low, the basis weight tends to be low and when the graft rate is high, the basis weight tends to be high.

The metal removal filtering material of the present invention includes the graft chains with the graft rate of 40 to 150%, the functional group selected from a quaternary ammonium group, a primary, secondary, or tertiary amino group, an iminodiacetic acid group, a phosphate group, and an iminodiethanol group is introduced into the graft chains. Moreover, the basis weight is in a range from 30 to 120 g/m², and therefore while the flow rate per unit area is maintained, high metal removal performance is provided and the organic solvent is not denatured.

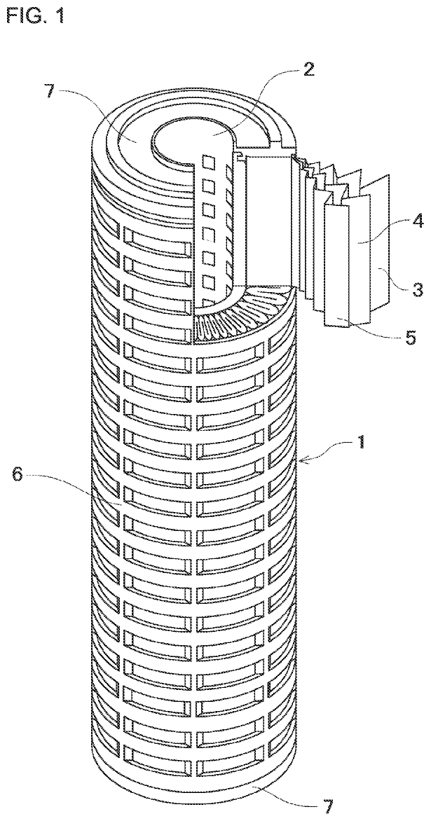

FIG. 1 illustrates a partial cutaway perspective view of the cartridge filter of the present invention. A cartridge filter 1 of the present invention includes a cylindrical core 2, a filtering material 4 covering the outer periphery of the core 2, a cylindrical protector 6 covering its outer periphery, and end caps 7 sealing both ends of the cylinder. The core 2 and the protector 6 have many liquid passage holes in the peripheral surfaces. All of the core 2, the protector 6, and the end caps 7 are made of high-density polyethylene.

The filtering material 4 is sandwiched by support nets 3, 5 made of high-density polyethylene to be stacked, and a pleating process is performed on the filtering material 4. This is formed in a cylindrical shape and longitudinal seal welding is performed on both ends of the cylinder for use.

As the filtering material 4, the metal removal filtering material of the present invention is used. The pleating process can be performed using one metal removal filtering material as a single layer, and a pleating process may be performed on two or more multilayers of the same metal removal filtering material. Furthermore, multilayers can be formed by combining metal removal filtering materials of different functional groups, and a pleating process can be performed on it for use.

The filtering material on which the pleating process has been performed is housed between the core 2 and the protector 6, both ends are thermally welded with the end caps for sealing to manufacture the cartridge filter 1 of the present invention. As necessary, acid pickling or water cleaning may be performed on this cartridge filter 1.

The cartridge filter of the present invention allows removing a metal at high level while maintaining the high flow rate. Moreover, this allows removing a trace amount of metal in an organic solvent without denaturing the organic solvent.

### EXAMPLES

Hereinafter, the present invention will be described specifically with reference to Examples. Materials, used amounts, rates, treatment procedures, and the like shown in the following Examples can be changed, if appropriate without departing from the gist of the present invention. Therefore, the scope of the present invention should not be construed as being limited by the specific examples described below.

<Manufacturing Metal Removal Filtering Material>

Using various polyethylene porous films, metal removal filtering materials of Examples 1 to 5 were manufactured. The following Table 1 summarizes the physical properties of the polyethylene porous films used.

TABLE 1

| | Exam- | Exam- | Exam- | Exam- | Exam- |
|---|---|---|---|---|---|
| | ple | ple | ple | ple | ple |
| | 1 | 2 | 3 | 4 | 5 |
| Basis weight (g/m²) | 43 | 16 | 30 | 30 | 43 |
| Thickness (μm) | 250 | 134 | 161 | 161 | 250 |
| Density (g/cm³) | 0.19 | 0.12 | 0.17 | 0.17 | 0.25 |
| Void rate (%) | 82 | 87 | 80 | 80 | 82 |
| IPA BP(kPa) | 21 | 15 | 12 | 12 | 21 |
| WFR (mL/min · cm²) | 35 | 87 | 83 | 83 | 35 |

Note that the bubble point (BP) was measured compliant to JIS K3832-1990 using isopropanol (IPA).

Compliant to JIS K3831-1990, a test pressure was set to be 69.3 kPa, and a time when water of 500 mL at a temperature of 25° C. flowing through an area of 9.6 cm² was measured to calculate the water flow rate (WFR).

### Example 1

A polyethylene porous film was irradiated with electron beam of a dose of 60 kGy under a nitrogen atmosphere. Afterwards, the product was immersed in 25% of a glycidyl methacrylate solution and was reacted at 60° C. for 40 minutes, and graft polymerization was performed to obtain a graft base material at a graft rate of 121%.

This was immersed in 8% of a sodium iminodiacetate aqueous solution and processed at 80° C. for 10 hours and an iminodiacetic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 217 mmol/m². The basis weight of this metal removal filtering material was 120 g/m².

### Example 2

A polyethylene porous film was irradiated with electron beam of a dose of 60 kGy under a nitrogen atmosphere. Afterwards, the product was immersed in 15% of a glycidyl methacrylate solution and was reacted at 60° C. for 40 minutes, and graft polymerization was performed to obtain a graft base material at a graft rate of 81%.

This was immersed in 8% of a sodium iminodiacetate aqueous solution and processed at 80° C. for 5 hours and an iminodiacetic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 41 mmol/m². The basis weight of this metal removal filtering material was 37 g/m².

### Example 3

A polyethylene porous film was irradiated with electron beam of a dose of 60 kGy under a nitrogen atmosphere. Afterwards, the product was immersed in 20% of a glycidyl methacrylate solution and was reacted at 60° C. for 40 minutes, and graft polymerization was performed to obtain a graft base material at a graft rate of 84%.

This was immersed in 85% of a phosphoric acid aqueous solution and processed at 95° C. for 24 hours and a phosphate group was introduced. After the graft base material into which the functional group had been introduced was immersed in hydrochloric acid of 1 mol/L, the product was rinsed with ultrapure water and dried to manufacture a metal removal filtering material having an amount of introduced functional group of 141 mmol/m². The basis weight of this metal removal filtering material was 68 g/m².

### Example 4

A polyethylene porous film was irradiated with electron beam of a dose of 60 kGy under a nitrogen atmosphere. Afterwards, the product was immersed in 20% of a glycidyl methacrylate solution and was reacted at 60° C. for 40 minutes, and graft polymerization was performed to obtain a graft base material at a graft rate of 84%.

This was immersed in 40% of a diethanolamine aqueous solution and processed at 80° C. for 24 hours and an iminodiethanol group was introduced. After the graft base material into which the functional group had been introduced was immersed in hydrochloric acid of 1 mol/L, the product was rinsed with ultrapure water and dried to manufacture a metal removal filtering material having an amount of introduced functional group of 221 mmol/m². The basis weight of this metal removal filtering material was 77 g/m².

### Example 5

A polyethylene porous film was irradiated with electron beam of a dose of 60 kGy under a nitrogen atmosphere. Afterwards, the product was immersed in 20% of a glycidyl methacrylate solution and was reacted at 60° C. for 60 minutes, and graft polymerization was performed to obtain a graft base material at a graft rate of 73%.

This was immersed in 6.6% of a sodium iminodiacetate aqueous solution and processed at 80° C. for 5 hours and an iminodiacetic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 22 mmol/m². The basis weight of this metal removal filtering material was 66 g/m².

The metal removal performance, the discoloration of the organic solvent, and occurrence of crack of the metal removal filtering materials of Examples 1 to 5 were examined.

To examine the metal removal performance, each of the metal removal filtering materials was punched to be 47 mm in diameter (effective filtration area: 13.5 cm²) and was installed in a holder made of PFA. As a metal-containing organic solvent, PGMEA containing each of Cr, Fe, and Ti by a concentration of about 20 ppb was prepared. Using each of the metal removal filtering materials, this metal-containing organic solvent was filtered at a flow rate of 5 mL/min to calculate a metal removal rate from the amounts of metal before and after the filtration. When all of the metals exhibit the removal rate of 85% or more, they are qualified.

For the discoloration of the organic solvent, each of the metal removal filtering materials was immersed in an organic solvent (cyclohexanone, PGMEA) and discoloration of the organic solvent and the filtering material after one week was visually checked.

Additionally, after each of the metal removal filtering materials was folded in two to provide a light fold line, a weight having a weight of 2.5 kg was dropped on the fold line from a height of 10 cm and the state of the fold line was observed by visual check to examine damage, such as a crack.

The following Table 2 summarizes the evaluation results of the metal removal filtering materials of Examples 1 to 5 with the respective configurations.

TABLE 2

| | | Example 1 | Example 2 | Example 3 | Example 4 | Example 5 |
|---|---|---|---|---|---|---|
| Basis weight (g/m²) | | 120 | 37 | 68 | 77 | 66 |
| Thickness (μm) | | 411 | 161 | 197 | 236 | 260 |
| IPA BP(kPa) | | 12 | 15 | 9 | 9 | 16 |
| WFR (mL/min · cm²) | | 47 | 99 | 127 | 128 | 54 |
| Graft rate (%) | | 121 | 81 | 84 | 84 | 73 |
| Functional group | | Iminodiacetic | Iminodiacetic | Phosphoric | Iminodiethanol | Iminodiacetic |
| | | acid | acid | acid | | acid |
| Amount of introduced | | 217 | 41 | 141 | 221 | 22 |
| functional group | | | | | | |
| (mmol/m²) | | | | | | |
| Removal rate after | Cr | 94.4 | 94.6 | 85.1 | 99.2 | 94.6 |
| 30 minutes (%) | Fe | 95.2 | 95.7 | 92.2 | 96.2 | 95.7 |
| | Ti | 96.6 | 96.8 | 91.9 | 97.2 | 95.8 |

| | | | | | |
|---|---|---|---|---|---|
| Discoloration of organic | None | None | None | None | None |
| solvent | | | | | |
| Occurrence of crack | None | None | None | None | None |

The metal removal filtering materials of Examples 1 to 5 have the basis weights of 37 to 120 g/m² and the graft rates of the graft chains of 73 to 121%. Moreover, since the iminodiacetic acid group, the phosphate group, or the iminodiethanol group is introduced into the graft chains, the metal removal rate is 85% or more and the organic solvent is not discolored, and a crack does not occur.

Using various porous films or nonwoven fabrics, the metal removal filtering materials of Comparative Examples 1 to 6 were manufactured. The following Table 3 summarizes the physical properties of the used porous films or nonwoven fabrics. Comparative Examples 1, 2, 5, 6 use polyethylene porous films and Comparative Examples 3, 4 use polyethylene nonwoven fabrics.

TABLE 3

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Basis weight (g/m²) | 43 | 30 | 80 | 80 | 43 | 14 |
| Thickness (μm) | 250 | 161 | 216 | 216 | 250 | 92 |
| Density (g/cm³) | 0.22 | 0.17 | 0.37 | 0.37 | 0.22 | 0.16 |
| Void rate (%) | 82 | 80 | 61 | 61 | 82 | 84 |
| IPA BP(kPa) | 21 | 12 | 7 | 7 | 21 | 23 |
| WFR (mL/min · cm²) | 35 | 83 | 27 | 27 | 35 | 74 |

### Comparative Example 1

A polyethylene porous film was irradiated with electron beam of a dose of 60 kGy under a nitrogen atmosphere. Afterwards, the product was immersed in 20% of a glycidyl methacrylate solution and was reacted at 60° C. for 60 minutes, and graft polymerization was performed to obtain a graft base material at a graft rate of 38%.

This was immersed in 6.6% of a sodium iminodiacetate aqueous solution and processed at 80° C. for 5 hours and an iminodiacetic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 13 mmol/m². The basis weight of this metal removal filtering material was 52 g/m².

### Comparative Example 2

A polyethylene porous film was irradiated with electron beam of a dose of 60 kGy under a nitrogen atmosphere. Afterwards, the product was immersed in 25% of a glycidyl methacrylate solution and was reacted at 60° C. for 40 minutes, and graft polymerization was performed to obtain a graft base material at a graft rate of 84%.

This was immersed in 10% of a sodium sulfite aqueous solution and processed at 95° C. for 24 hours and a sulfonic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 234 mmol/m². The basis weight of this metal removal filtering material was 78 g/m².

### Comparative Example 3

A polyethylene nonwoven fabric was irradiated with electron beam of a dose of 60 kGy under a nitrogen atmosphere. Afterwards, the product was immersed in 100% of a glycidyl methacrylate solution and was reacted at 60° C. for 40 minutes, and graft polymerization was performed to obtain a graft base material at a graft rate of 119%.

This was immersed in 10% of a sodium sulfite aqueous solution and processed at 95° C. for 24 hours and a sulfonic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 970 mmol/m². The basis weight of this metal removal filtering material was 250 g/m².

### Comparative Example 4

A polyethylene nonwoven fabric was irradiated with electron beam of a dose of 60 kGy under a nitrogen atmosphere. Afterwards, the product was immersed in 100% of a glycidyl methacrylate solution and was reacted at 60° C. for 40 minutes, and graft polymerization was performed to obtain a graft base material at a graft rate of 119%.

This was immersed in 20% of a sodium iminodiacetate aqueous solution and processed at 60° C. for 24 hours and an iminodiacetic acid group was introduced. After the graft base material into which the functional group had been introduced was immersed in hydrochloric acid of 1 mol/L, the product was rinsed with ultrapure water and dried to manufacture a metal removal filtering material having an amount of introduced functional group of 506 mmol/m². The basis weight of this metal removal filtering material was 240 g/m².

### Comparative Example 5

A polyethylene porous film was irradiated with electron beam of a dose of 150 kGy under a nitrogen atmosphere. Afterwards, the product was immersed in 100% of a glycidyl methacrylate solution and was reacted at 60° C. for 60 minutes, and graft polymerization was performed to obtain a graft base material at a graft rate of 547%.

This was used as a metal removal filtering material. The basis weight was 241 g/m².

### Comparative Example 6

A polyethylene porous film was irradiated with electron beam of a dose of 60 kGy under a nitrogen atmosphere. Afterwards, the product was immersed in 25% of a glycidyl methacrylate solution and was reacted at 60° C. for 40 minutes, and graft polymerization was attempted. However, it was broken during a continuous process of a roll, failing to obtain a metal removal filtering material.

The metal removal performance, the discoloration of the organic solvent, and occurrence of crack of the metal removal filtering materials of Comparative Examples were examined similarly as described above. The following Table 4 summarizes the evaluation results with the respective configurations.

TABLE 4

| | | Comparative | Comparative | Comparative | Comparative | Comparative |
|---|---|---|---|---|---|---|
| | | Example 1 | Example 2 | Example 3 | Example 4 | Example 5 |
| Basis weight (g/m²) | | 52 | 78 | 250 | 240 | 241 |
| Thickness (μm) | | 240 | 234 | 478 | 453 | 740 |
| IPA BP(kPa) | | 17 | 7 | 6 | 5 | — |
| WFR (mL/min · cm²) | | 52 | 145 | 9 | 64 | — |
| Graft rate (%) | | 38 | 84 | 119 | 119 | 547 |
| Functional group | | Iminodiacetic | Sulfonic | Sulfonic | Iminodiacetic | — |
| | | acid | acid | acid | acid | |
| Amount of introduced functional | | 13 | 234 | 970 | 506 | — |
| group (mmol/m²) | | | | | | |
| Removal rate after | Cr | 95.0 | 94.7 | 68.6 | 67.3 | — |
| 30 minutes (%) | Fe | 82.6 | 96.5 | 70.0 | 76.9 | — |
| | Ti | 94.5 | 96.9 | 77.9 | 66.6 | — |

| | | | | | |
|---|---|---|---|---|---|
| Discoloration of organic solvent | None | Present | Present | Present | — |
| Occurrence of crack | None | None | None | None | Present |

The removal rate of Fe of the metal removal filtering material of Comparative Example 1 is less than 85%. It is estimated that this is caused by the graft rate being less than 40% (38%).

In the metal removal filtering material of Comparative Example 2, the organic solvent was discolored. In the metal removal filtering material of Comparative Example 3, in addition to the discoloration of the organic solvent, the removal rate of the metal is less than 85%. The organic solvent is discolored by the influence of the sulfonic acid group. In Comparative Example 3, the basis weight exceeds 120 g/m² (250 g/m²) and further the nonwoven fabric is used, and therefore the high metal removal rate cannot be obtained.

In the metal removal filtering material of Comparative Example 4, the basis weight exceeds 120 g/m² and further the nonwoven fabric is used, and therefore the metal removal rate is 76.9% at the maximum. In the metal removal filtering material of Comparative Example 5, the basis weight exceeds 120 g/m² and the graft rate exceeds 150%, and therefore a crack occurs and a pleating process cannot be performed.

It has been confirmed that when any one of the conditions of the basis weight, the graft rate, and the introduced functional group is not satisfied, the metal removal filtering material having high metal removal performance while maintaining the flow rate per unit area and not denaturing the organic solvent cannot be obtained.

<Manufacturing Cartridge Filter>

Using the metal removal filtering material of Example 1 as a filtering material, the cartridge filter as illustrated in FIG. 1 was manufactured. First, the metal removal filtering material was sandwiched between polyethylene meshes as the supports 3, 5 to be stacked, and a pleating process was performed. This was disposed on a circumference between the core 2 and the protector 6, and both end portions were thermally welded with the end caps 7. Thus, a cartridge filter having a dimension of 970 mm×250 mm and an effective filtration area of 0.79 m² was obtained. Furthermore, after the manufactured cartridge was immersed in 5% of hydrochloric acid for 24 hours, ultrapure water was flowed for cleaning until the residual of the hydrochloric acid disappeared.

A metal-containing organic solvent (solvent: PGMEA) prepared such that each of Ti, Cr, and Fe, became about 20 ppb was filtered through this cartridge filter at a flow rate of 3 L/min, and the metal removal rate was calculated from the amounts of metal before and after the filtration. As a result, the removal rate of each metal was 93 to 98% and the satisfactory metal removal performance was confirmed.

According to the present invention, using the polyethylene porous base material having the basis weight of 15 to 50 g/m² and the void rate of 70% or more and setting the graft rate to be 40 to 150% allow increasing the contacted area between liquid to be treated and the metal removal filtering material and achieve the filter with high metal removal performance while maintaining the high flow rate. Moreover, introduction of the chelate group or the anion-exchange group allows removing the trace amount of metal in the organic solvent without denaturing the organic solvent.

### DESCRIPTION OF REFERENCE SIGNS

1 . . . cartridge filter
2 . . . core
3, 5 . . . support
4 . . . filtering material
6 . . . protector
7 . . . end cap

1. A metal removal filtering material having a basis weight of 30 to 120 g/m², comprising:
a polyethylene porous base material; and
graft chains fixed to the polyethylene porous base material and having a functional group, wherein
the graft chains have a graft rate of 40 to 150%, and
the functional group is selected from a quaternary ammonium group, a primary, secondary, or tertiary amino group, an iminodiacetic acid group, a phosphate group, and an iminodiethanol group.

2. The metal removal filtering material according to claim 1, wherein
the polyethylene porous base material is a polyethylene porous film.

3. A manufacturing method for the metal removal filtering material according to claim 1, comprising:
polymerizing a vinyl group-containing reactive monomer in a polyethylene porous base material having a basis weight of 15 to 50 g/m² and a void rate of 70% or more by radiation graft polymerization to fix graft chains having a graft rate of 40 to 150%; and
introducing the functional group selected from the quaternary ammonium group, the primary, secondary, or tertiary amino group, the iminodiacetic acid group, the phosphate group, and the iminodiethanol group into the graft chains.

4. The manufacturing method of the metal removal filtering material according to claim 3, wherein
the polyethylene porous base material is a polyethylene porous film.

5. A cartridge filter comprising:
a pleating-processed filtering material, wherein
the filtering material is the metal removal filtering material according to claim 1.

6. A cartridge filter comprising:
a pleating-processed filtering material, wherein
the filtering material is the metal removal filtering material according to claim 2.
